(19) United States
(12) Patent Application Publication
(10) Pub. No.: US 2006/0197474 A1
(43) Pub. Date: Sep. 7, 2006

(54) Modular lighting system

(76) Inventor: Jeremy E. Olsen, Pleasant Grove, UT (US)

Correspondence Address: DAVID R. MCKINNEY, P.C., 8 EAST BROADWAY, SUITE 500, SALT LAKE CITY, UT, 84111, US

(21) Appl. No.: 11/074,601

(22) Filed: Mar. 7, 2005

(51) Int. Cl. H05B 39/00

(52) U.S. Cl. 315/312

(57) ABSTRACT

A modular lighting system includes a multiple conductor wire, including a common data wire, and a plurality of nodes, disposed along the multiple conductor wire. Each node includes an LED and a node microprocessor, having a unique address. The node microprocessor is configured to independently control illumination of the LED according to node-specific operating instructions that are transmitted via the common data wire.

### BACKGROUND

1. Field of the Invention

The present invention relates generally to LED lighting systems. More particularly, the present invention relates to a modular system for providing and controlling a plurality of LED lights along a common conductor wire.

2. Related Art

Light-emitting diodes (LEDs) are becoming increasingly popular as replacements for incandescent bulbs and other lighting devices in a variety of applications. Until recently, the use of LEDs has tended to be limited to single-bulb use in relatively low light applications, such as miniature train sets, instrument panels, electronics, pen lights and, more recently, outdoor decorative lights such as Christmas lights. However, more recent developments have broadened their utility and applicability. This wider use of LEDs is readily visible in traffic lights, automobile tail lights and head lights, and other common applications. Also, because of their low power consumption and high light output, LEDs are becoming increasingly popular for battery-powered items, such as flashlights.

Several factors have contributed to the wider use of LEDs. One factor is power. In recent years, more powerful LEDs have been developed, providing single devices with power output of up to 5 or 10 watts, with even more powerful devices on the horizon. The increased power allows LEDs to be used in applications where greater light is needed. Additionally, recent improvements in manufacturing have lowered the cost of LEDs, making them more affordable. Moreover, a wide variety of LED products are now available, making them easily adaptable to many different uses. For example, LEDs are now available in clusters, such as from 2 to 36 LEDs, allowing the use of many low output LEDs to provide a high output array, such as for household lighting and vehicle headlamps. LED's are also available in arrays which fit standard AC and DC receptacles, lamps, recessed and track lights.

LEDs provide a wide range of advantages over conventional light bulbs. First, they are long-lasting. LED devices last about 10 times as long as compact fluorescent bulbs, and as much as 133 times longer than typical incandescent bulbs. Because these devices last for years, maintenance and replacement costs are greatly reduced. Also, LEDs are durable, and hold up well to jarring and bumping. Since LEDs do not have a fragile filament, they are not damaged under circumstances in which an incandescent bulb would be broken. Additionally, LEDs run cool, which reduces heat build-up. For example, one particular size of LED produces about 3.4 btu/hour, compared to 85 btu/hr for a comparable incandescent bulb.

Perhaps most importantly, LEDs are more energy-efficient than conventional bulbs. LEDs use a fraction of the power of incandescent bulbs, and can reduce electricity costs by 80% or more. For example, a string of 600 miniature incandescent Christmas lights uses about 0.27 killowatts per hour, while a comparable string of 600 LED lights uses about 0.021 killowatts per hour, or less than one tenth the power. Because of such energy savings, the U.S. Department of Energy has estimated that if all conventional incandescent Christmas lights in the U.S. were replaced with LED lights, annual energy savings would total about 2 billion kilowatt-hours. This is enough energy to power 200,000 homes for an entire year.

While LEDs are still significantly more expensive than incandescent or fluorescent light devices of comparable illumination, their cost is continually coming down. Moreover, in many cases the cost can be recouped over time in energy savings and reduced replacement costs. For example, AC devices and large cluster LED arrays are economical in applications where maintenance and replacement costs are high. Traffic lights are one example of such an application. Because of the low power consumption of LEDs, many cities in the US are replacing their incandescent traffic lights with LED arrays. Similarly, with LEDs, batteries in battery-powered devices can last 10 to 15 times longer than with incandescent bulbs. This low power consumption also makes LEDs useful for providing light for remote areas. Because of their low power consumption, solar-electric systems are more practical and feasible in remote areas, where it would be far more expensive to run an electric line or use a generator.

LEDs are available in a variety of colors, including white, red, green, and blue. Certain colors are particularly suited to, and popular in, certain applications. White LEDs are the most popular. White LEDs produce a soft white light, without harsh reflection, glare or shadows. White LEDs provide a cooler light than the yellow light that incandescent bulbs produce. Red LEDs are often used in situations where it is desirable to maintain night vision. Green LEDs are often used for pilots and the military. Like red, green can also help retain night vision, and does not obscure red markings on maps and charts. Blue LEDs are very easy on the eyes, and are popular for reading lights, especially for the elderly.

Finally, single red-green-blue (RGB) LEDs are also available. These devices produce all three colors, and can do so at any relative output intensity. By producing and mixing these three colors, RGB LEDs provide almost infinite color variation. Thus, when associated with suitable control electronics, one LED device can produce any desired color, and the color and intensity can be varied over time in any desired way.

While LEDs can do a variety of things, because they are semiconductor devices, controlling them in any unusual way (e.g. more than merely on/off) requires electrical circuitry with proper programming. This factor diminishes the flexibility of LEDs in many instances. For example, while RGB LEDs are available, their use in the same manner as conventional Christmas lights generally will not allow exercise of their entire functionality, at least not in any flexible way. A simple two-wire strand is only configured to provide on/off functionality, or to allow uniform control of all connected LEDs when associated with proper control circuitry. Moreover, even where LEDs are substituted for incandescent or other bulbs, typical lighting systems are generally inflexible, and do not allow significant reconfiguration.

### SUMMARY

It has been recognized that it would be advantageous to develop an LED lighting system that allows flexible independent control of a plurality of LEDs having a variety of functional states.

It has also been recognized that it would be advantageous to develop an LED lighting system that is flexible and easily reconfigurable.

Advantageously, in accordance with one embodiment thereof, the invention provides a modular lighting system, comprising a multiple conductor wire, including a common data wire, and a plurality of nodes, disposed along the multiple conductor wire. Each node includes an LED and a node microprocessor, having a unique address. The node microprocessor is configured to independently control illumination of the LED according to node-specific operating instructions that are transmitted via the common data wire.

In accordance with another embodiment thereof, the invention provides a lighting device, comprising an LED, having multiple operational states, and a dedicated microprocessor, associated only with the LED, and having a unique address. The microprocessor is configured to receive control signals for only the LED from a data wire, and to control the operation of only the LED.

In accordance with yet another embodiment thereof, the invention provides a modular lighting device, comprising a microprocessor circuit, having a unique address, an LED, attached to the microprocessor circuit and controlled thereby, a housing, enclosing the microprocessor circuit and the LED, and configured to allow broadcast of light from the LED, and a releasable connector, associated with the housing. The releasable connector includes a plurality of contacts, interconnected to the microprocessor circuit, and is configured to selectively attach and reattach the housing to a desired location on a multiple conductor wire, with the plurality of contacts each contacting one wire of the multiple conductors, so as to allow the LED to be independently controlled based upon signals from a data wire of the multiple conductor wire.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a plan view showing one embodiment of a modular lighting system in accordance with the present invention;

FIG. 2 is a perspective view of a modular LED node attached to a 3-conductor wire, in accordance with one embodiment of the present invention;

FIG. 3 is a top view of the LED node and conductor wire of FIG. 2;

FIG. 4 is a partial cross-sectional, partially exploded side view of the node and conductor wire of FIG. 2, taken along line 4-4 in FIG. 3;

FIG. 5 is a partial cross-sectional side view of the node and conductor wire of FIG. 2 taken along line 4-4 in FIG. 3;

FIG. 6 is a side view (showing the wire in cross-section) of an alternative embodiment of an LED node having a hinged back cover and wire channels configured for a wire of irregular cross-sectional shape;

FIG. 7A is a top view of the circuit board of the node embodiment of FIGS. 1-4, showing the LED and some of its control circuitry;

FIG. 7B is a bottom view of the circuit board of the node embodiment of FIGS. 1-4, showing additional control circuitry;

FIG. 8 is a top view of an alternative LED node configured for a 2-conductor wire;

FIG. 9 is a partial cross-sectional, partially exploded side view of the node and conductor wire of FIG. 8, taken along line 9-9 in FIG. 8;

FIG. 10 is a partial cross-sectional side view of the node and 2-conductor wire, taken along line 9-9 in FIG. 8;

FIG. 11A is a top view of the circuit board of the node embodiment of FIGS. 8-10, showing the LED and some of its control circuitry;

FIG. 11B is a bottom view of the circuit board of the node embodiment of FIGS. 8-10, showing additional control circuitry;

FIGS. 12A-12C are front, side, and back views, respectively, of an alternative LED node having an elongated shape;

FIG. 13 is a block diagram of the node hardware and software; and

FIG. 14 is a block diagram of the interface hardware and software.

Reference will now be made to exemplary embodiments illustrated herein, and specific language will be used to describe the same. It will nevertheless be understood that no limitation of the scope of the invention is thereby intended.

### DETAILED DESCRIPTION

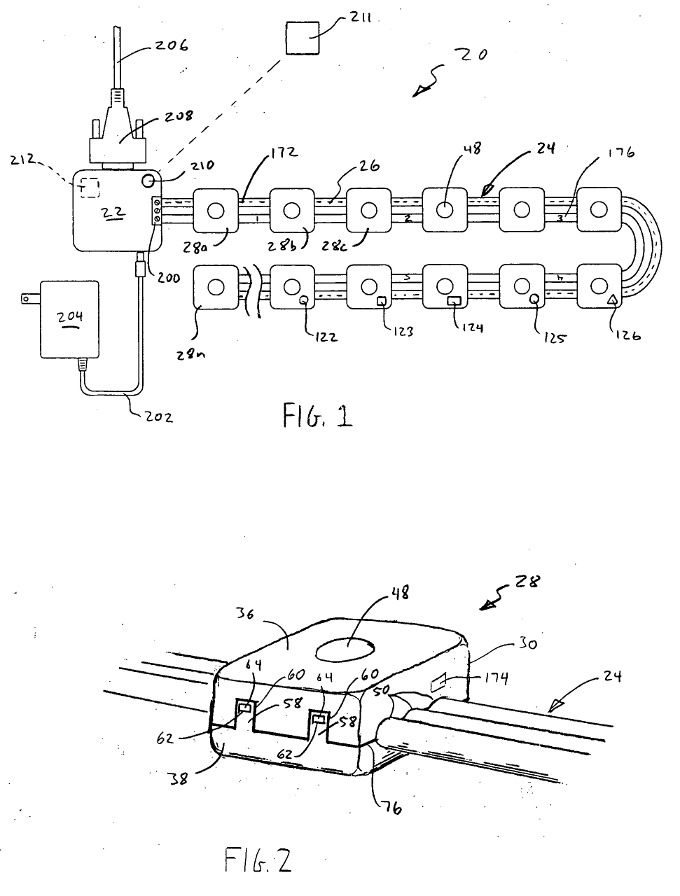

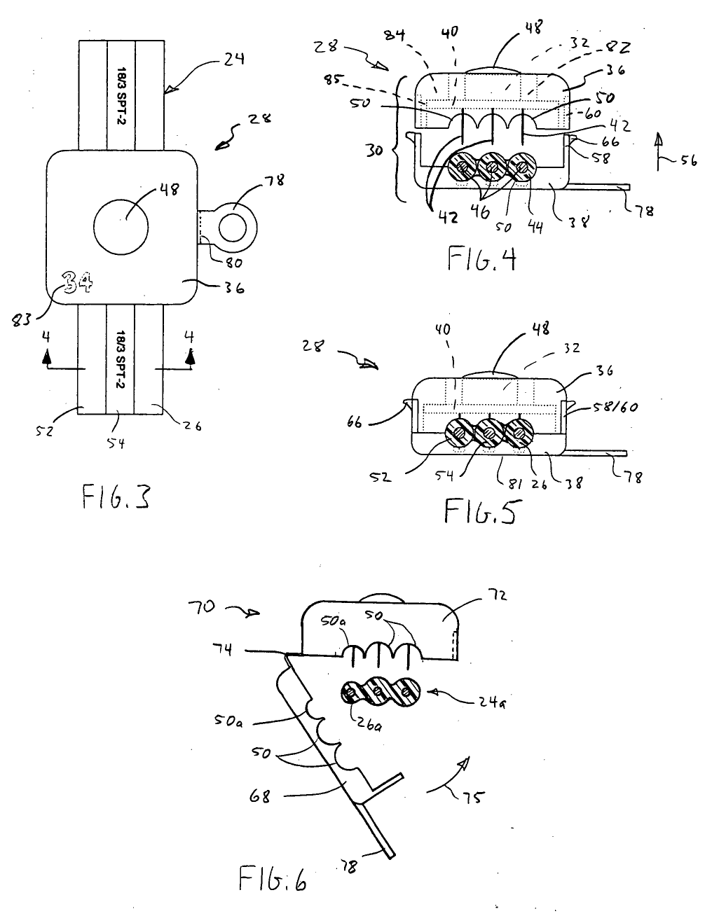

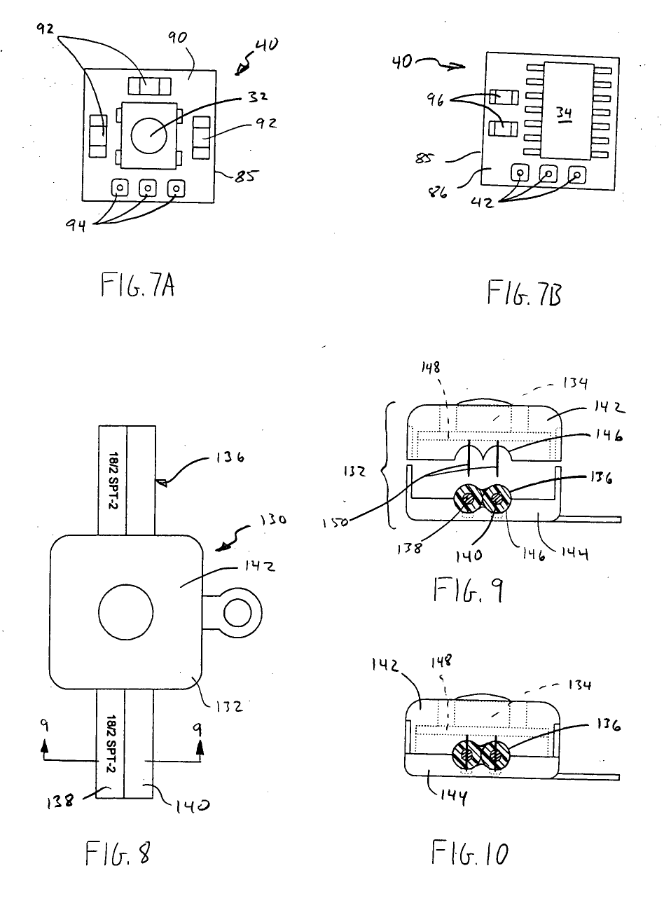

One embodiment of a modular lighting system in accordance with the invention is shown in FIG. 1. The lighting system 20 comprises a microprocessor interface 22, a multi-conductor (e.g. 3 conductors) wire 24, including a data line 26, and a plurality of modular LED nodes 28a-n disposed along the wire. As shown in FIGS. 2-5, each node comprises a modular housing 30 that is selectively attachable to and removable from the multi-conductor wire at any desired location. Each housing contains an LED or LED array 32 that is mounted upon a circuit board (40 in FIG. 4), which also supports a dedicated microprocessor chip (34 in FIG. 7B) and related circuitry.

As used herein, the terms “LED” and “LED array” are used interchangeably to refer to the actual light emitting diode 32 (or array of light emitting diodes) associated with a single node. The term “node” is used to refer to the entire lighting unit, i.e. the housing 30 and everything contained in it, including the LED, the circuit board 40, and the microprocessor 34.

Each microprocessor chip 34 has a unique address, allowing each LED array to be independently controlled by commands from the common data wire 26. Control signals from the interface 22 are encoded specifically for each node 28, which allows the timing, color, and intensity of each LED array to be independently controlled according to an overall plan or program, or randomly, or in any other desired manner. The system 20 thus allows the full functionality of multi-state LEDs (e.g. red-green-blue) to be exploited in a simple system that is reconfigurable according to a user's tastes and preferences. Advantageously, because the wire 24 is relatively inexpensive, a user can easily remove the nodes whenever desired, discard the used wire, and start with a new wire for relatively little cost.

Various views of one embodiment of a single node 28 connected to a multiple conductor wire 24 are shown in FIGS. 2-5. The housing 30 of each LED node comprises a top portion 36 and a bottom portion 38, which are configured to releasably attach around the multiple conductor wire. The housing can be made of injection-molded plastic, for example, for light weight and durability, though other materials can also be used. It is also desirable that the material of the housing be UV and weather resistant if the system is to be used outdoors. Disposed within the housing is a printed circuit board 40 that supports the LED 32 and the microprocessor chip 34 and related circuitry that controls the LED. Descending downwardly from the printed circuit board are several contact pins 42 that are configured to pierce the insulation 44 of the multiple conductor wire when the node is attached to the wire, to make contact with the respective conductors 46.

The top portion 36 of the housing 30 includes a window or lens 48, through which light from the LED 32 is directed. The lens protects the LED, and is securely fastened to the top portion of the housing, so as not to be easily damaged or dislodged. The lens can also be configured for various optical effects, and can be interchangeable. As is well known, LEDs are focused lights and naturally have a limited light field. They provide greatest brightness in the direction of orientation, and far less light therearound. They do not naturally radiate light in 360 degrees, as an incandescent bulb does, unless provided with lenses or other optical elements to distribute the light. Visibility within a larger field of view is possible with the use of clusters of LEDs, and/or with suitable optical elements. Accordingly, the lens 48 can be configured to provide wider or narrower dispersal of the LED light, as desired. The lens can also be colored, provided with a diffusion coating, or configured to provide other optical properties or effects.

In the embodiment shown in FIGS. 2-5, the top portion 36 and bottom portion 38 of the housing 30 include channels 50 which are configured to receive and conform to opposing sides, respectively, of the multi-conductor wire 24. This configuration helps to properly position the wire, and to seal around it when the housing is closed. Advantageously, the LED nodes 28 self-crimp onto the wire, without the need for special tools, as is the case with some other connectors, such as insulation displacement connectors (IDC).

In the embodiment of FIGS. 1-5, the wire 24 is a 3-conductor wire, having a data line 26, as noted above, and also a ground line 52 and power line 54. The power line provides electrical power to all of the nodes 28, while the data line 26 carries unique control signals to each node. Viewing FIGS. 4 and 5, when the wire 24 is properly positioned in the channels 50 of the bottom portion 38 of the housing 30, the bottom portion can be pushed upwardly toward the top portion 36 (in the direction of arrow 56 in FIG. 4), such that the contact pins 42 each pierce the insulation 44 of the wire to make contact with a respective conductor 46 of the multiple-conductor wire.

The housing 30 is provided with a latching mechanism to hold the top and bottom portions 36, 38 together. This latching mechanism can be configured in various ways. As best shown in FIG. 2, the bottom portion 38 includes flexible interlocking tabs 58 that snap into place in interlocking recesses 60 in the sides of the top portion 36. The interlocking tabs each include a window 62, which is configured to snap over a protrusion 64 extending from the top portion within the respective interlocking recess when the interlocking tab is fully inserted therein. This connection provides a compact, durable device that securely attaches to the wire at any desired location. It should be apparent, however, that this particular latching design is only one of many possible configurations. For example, the housing can be provided with internal tabs or clasps (not shown), with interlocking recesses in the inside of the housing, or some other latching mechanism or configuration.

Advantageously, after attachment of a node 28 to the wire 24 at a given location, the LED nodes can be removed and relocated at will. The housing 30 is configured such that the bottom portion 38 can be easily removed from the top portion 36 without damaging either half. To remove a node, the user simply bends the interlocking tabs 58 outwardly away from the respective interlocking recesses 60, so as to clear the protrusions 64, allowing the bottom portion to be removed from the top portion. To facilitate removal, the interlocking tabs can include a flange 66, shown in FIGS. 4 and 5, that extends from the distal end of the interlocking tab, allowing a user to easily bend the tab outwardly using a finger or a tool.

The housing 30 shown in FIGS. 1-4 and 7-9 is a two-piece housing. With 2-piece construction, it is possible to fit different styles of bottom portions 38 onto the housing, which could allow different wire gauges and different attachment methods to be used. Alternatively, the housing can be configured as a one-piece unit, as shown in FIG. 6. In this configuration the bottom portion 68 of the housing 70 is hingedly connected to the top portion 72 (e.g. via a flexible strip or “living hinge” 74) and simply snaps closed over the wire 24a, in the direction of arrow 75. This configuration can make it easier to attach the node to the wire, and also reduces the number of separate parts in the system, though it does not allow the flexibility of different types or styles of backs to be used, as mentioned above. It will also be apparent that other one and two-piece configurations are also possible.

The housing 30 can be configured to be water-resistant when closed, so as to protect the LED 32 and other components contained inside. It is desirable that the housing meet IP64 or NEMA 3 ratings, though such is not required in order to practice the invention. Water-tightness can be facilitated by a resilient rubber layer or coating (not shown) disposed at the wire entry and exit points—that is, along the edges of the channels 50—and also around the mating edges (76 in FIG. 2) of the top and bottom portions 36, 38, respectively. The entire housing can also be treated to protect it from moisture, such as with silicon-based or other coatings, conformal coatings, or other treatments that help repel water and/or protect from dirt, dust, etc. The printed circuit board 40 can also be potted in epoxy or otherwise coated to protect it from moisture that might get into the housing.

The last node on a wire (e.g. node 28n in FIG. 1) can have a special configuration so that the conductors 46 of the wire 24 are not exposed at a terminal end of the wire. This can be done in many ways. For example, the last node can be provided with a molded plug (not shown) to fill the wire channels 50 on the side of the node where the wire does not exit. Alternatively, a special “last node” bottom cover (not shown) with a built-in plug can be provided. As yet another alternative, the wire can simply extend through the last node, with some other device or substance (e.g. a water-tight cap or coating) placed over the free end of the wire to cover and protect the conductors.

Whether a one-piece or two-piece design, the housing 30 can include a variety of other external features. As shown in FIGS. 3-5, the bottom portion 38 of the housing can include a mounting flange 78 that allows a node to be attached to a support structure with screws, nails, hooks, or other fastening devices. The mounting flange can be designed to be easily broken or cut off, if desired (e.g. by means of a score or frangible connection 80 in FIG. 3). The bottom portion of the housing can also include a recess (not shown) to accommodate a magnet for magnetic attachment. Other recesses can also be provided to accommodate nail or screw mounting. The back surface (81 in FIG. 5) of the bottom portion can also be configured (e.g. made smooth) to allow tape or other adhesive to stick to it. The bottom portion can also be beveled at its edges to allow it to fit neatly into corners.

The housing 30 can also include various indicia. These can be provided in various ways, such as printed on, molded into the material of the housing, or printed on an adhesive label. The indicia can include a variety of desirable information, such as an identifying designation (83 in FIG. 3) for the node, or a diagram of how to properly connect the wires, etc.

The housing 30 can be designed to prevent a node 28 from being attached to the cable 24 in an incorrect orientation. In the embodiments of FIGS. 1-4 and FIGS. 7-9, the wire channels 50 are configured such that the housing can only snap shut when the wire is properly positioned in the channels. Additional geometric features can also be provided to help ensure proper connection of the contact pins 42 to their respective conductors 46. For example, the multiple conductor wire 24 can be configured with one conductor (e.g. the data wire 26) having a substantially different size or shape than the other conductors. This sort of configuration is depicted in FIG. 6. In this embodiment, one of the conductors 26a in the multiple conductor wire 24a is significantly smaller in diameter than the other conductors. Likewise, the channels 50 in the housing for receiving the wire vary in size, with one channel being smaller than the others. Because of this corresponding asymmetry, the housing can be attached to the multiple conductor wire with the wire in one and only one orientation. In FIG. 6, the leftmost wire channel 50a is smaller than the other two. Accordingly, the housing can only be attached to the multiple conductor wire with the smaller conductor 26a aligned with the smaller channel. This asymmetrical configuration helps ensure that the contact pins contact the intended wire, and helps to prevent possible damage to the device if it is connected improperly.

Alternatively or concurrently, the nodes can be provided with electronic circuitry (e.g. one or more diodes) to provide reverse current protection. This can help protect the microprocessor and related circuitry from damage in case a node is attached to the multi-conductor wire in the wrong orientation (i.e. the pins contacting the incorrect conductors of the wire).

Referring back to FIG. 4, the printed circuit board 40, to which the LED 32, microprocessor 34, and related electronics are attached, fits into a recess 82 in the top portion 36 of the housing 30. The circuit board can be affixed within the housing in various ways. The inside of the top portion can include tabs or standoffs 84 that secure the circuit board into place with a press-fit. The tabs can be configured to wrap around the edges 85 of the circuit board to contact the back or bottom 86 of the circuit board to hold it in place, yet remain clear of the sides of the wire 24. Alternatively, the housing can include stanchions (not shown) with threaded holes to allow the circuit board to be affixed in the housing with screws. Whatever the method of affixing the circuit board within the housing, it is desirable that the circuit board be affixed securely enough to be held in place when the wire is removed from the pins 42.

The contact pins 42 are directly attached to and descend downwardly from the circuit board 40. The inventor has found it desirable to place the pins close to the edge of the circuit board so as to help center the wire 24 over the pins when they are pierced. The standoffs, tabs, or stanchions in the top portion 36 of the housing 30 can be configured to allow enough clearance for the pins. The bottom portion 38 of the housing includes recesses 88 for accommodating the distal ends of the pins, should they pierce entirely through a wire.

Top and bottom views of a printed circuit board 40 configured for the three-wire node of FIGS. 2-5 are provided in FIGS. 7 and 8. The circuitry for controlling the node is relatively simple. Viewing FIG. 7 the top 90 of the circuit board includes the LED array 32, a group of resistors 92, and solder points 94 for the contact pins 42. Various LED arrays from various sources can be used. A single color LED that is simply on/off controlled can be used. Alternatively, LED arrays that provide more functionality, such as multiple colors (e.g. red-green-blue LEDs), with voltage regulation to provide a range of light intensity, can also be used. One suitable red-green-blue LED array that the inventor has used is item number GM5WA02200A from Sharp electronics.

Viewing FIG. 8, the bottom 86 of the circuit board 40 includes the microprocessor chip 34, another group of resistors 96, and the contact pins 42. The resistors serve two purposes. First they limit the amount of current through the LED 32, thus protecting the LED and the microprocessor from over-current situations. Second, they help to balance the perceived light output of each LED in the array, so as to effectively “trim” the LED output. The microprocessor chip includes digital memory for storing node-specific operating instructions for the associated LED. A microprocessor that the inventor has used is a PIC processor PIC16F688 from Microchip Technology, Inc. While an external quartz crystal oscillator could alternatively be used, this particular microprocessor utilizes an internal, precision-calibrated 8 MHz RC oscillator, which reduces EMI (Electo-Magnetic Interference) emissions and reduces costs compared to an external quartz crystal oscillator. The microprocessor uses PWM (Pulse Width Modulation) to limit the overall current drawn by each LED. This PWM has a nominal output frequency of 100 Hz, which is considered by some to be the minimum frequency required to eliminate the perception of flickering. The PWM also has a duty cycle resolution of 1 in 256. This allows the microprocessor to provide 256 levels of light output per LED, which, when connected to a three-LED array, provides more than 16 million possible output combinations.

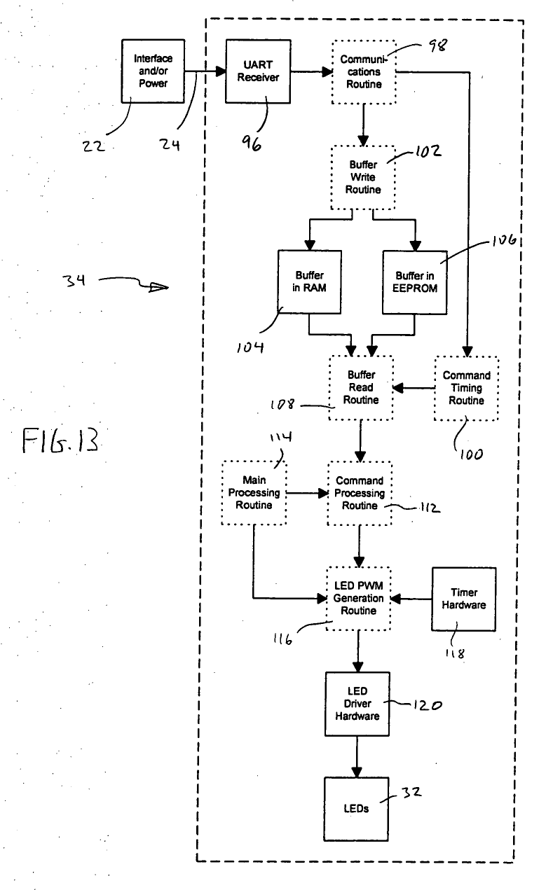

The physical components (hardware) and operating routines (software) for one LED node embodiment are shown in a block diagram in FIG. 13. Hardware components of the interface are shown as solid line boxes, while the software steps are shown as dashed line boxes. All of the hardware components are part of the node circuitry, and operate according to the programming steps shown. The node circuitry includes a UART (Universal Asynchronous Receiver-Transmitter) receiver 96 that receives electrical power and control instructions from the interface 22 through the multi-conductor wire 24. The signals that are received are processed through a communications routine 98 that separates out timing signals and sends them to a command timing routine 100. A buffer write routine 102 writes the control instructions into either a RAM buffer 104, or an EEPROM buffer 106. The buffer read routine 108, in concert with the command timing routine 100, then processes the control instructions. A command processing routine 112 and main processing routine 114 then provide data to the LED PWM generation routine 116, which, in response to signals from the timing circuit 118, provide direct control signals for the LED driver hardware 120, which drives the LED array 32.

The node microprocessor 34 can be programmed to provide a wide variety of functions. It can queue the commands it receives from the interface for execution at a later time, or it can execute these commands immediately. The microprocessor can include a morph function, which sets beginning and ending colors and a time interval. Under this function the microprocessor then calculates all of the colors between the beginning and ending colors, and gradually changes the output of the LED from the beginning to the ending color over the specified time interval. A “random RGB values/patterns” function can be provided which causes a node to generate random values as output to its LEDs. The random values can be directed to any or all of the output characteristics of the LEDs, including on/off condition, illumination intensity, and color. This type of command can be used to provide many desirable effects. For example, with proper constraints on the range of color and intensity variation and the timing, a candle flicker appearance can be created.

Other functions are also possible. For example, the microprocessor can be configured to have a timeout reset function following a loss of signal. For this function, the microprocessor can use a WDT (watch dog timer) circuit, which automatically resets the device in the event of an abnormal software execution condition. It can also include default power-up RGB values stored in EEPROM. This can involve a command or sequence of commands to set a single node or all nodes back to factory defaults. These and a wide variety of other configuration settings can be stored permanently in EEPROM.

The microprocessor 34 can be configured to provide additional features as well. For example, the nodes 28 can be configured to power on/off based on commands from the interface 22. The system can also be configured to sense the current sent to the nodes from the interface. Additionally, the nodes can be configured to send data back to the interface. This can reduce the amount of data the interface is required to store in memory. For example, rather than storing all commands that have been sent to each node, the interface can simply “ask” each node which commands it currently has, and its operational state. The data feedback function can also serve other purposes, such as to send diagnostic information regarding the condition of the nodes. For example, each node could monitor its own power consumption, and if the power draw exceeds a threshold that indicates a malfunction, a signal could be sent back to the interface, and the interface could then turn that node off. Many other features are also possible.

Input nodes can also be provided. For example, certain nodes can be configured with input devices, such as sensors, examples of which are shown in FIG. 1. For example, a node can include a photo sensor 122 to detect ambient light, a temperature sensor 123, a motion detector 124, a microphone 125, or a wind sensor 126. Other options can include nodes that can be clamped to a wire. These input nodes can be configured to send signals back to the interface 22, or to other nodes. Alternatively, the interface itself can be provided with any or all of these types of input devices. The input devices can allow conditional operation of the system, or provide input to modify its operation. For example, the system can be configured to power-up only when the photo sensor reports ambient light below a certain level, or only when the motion detector detects motion. Alternatively, the temperature sensor can be configured to indicate an abnormal operating condition of a node, sending a corresponding signal to the interface and allowing the system to turn off that node. Many other types of nodes are also possible.

An alternative embodiment of an LED node 130 is shown in FIGS. 8-10. This embodiment is much like that of FIGS. 2-5, and provides a housing 132 having an LED array 134 that is controlled by signals transmitted through a common multiple conductor wire 136. However, in this embodiment the wire comprises two-conductors, rather than three conductors. In this embodiment, one conductor 138 is a ground wire, and the other conductor 140 is both the power and data line. The top and bottom housing portions 142, 144, have channels 146 for the wire and are configured to sandwich the wire and interconnect in a manner similar to that described above. However, the circuit board 148 includes only two pins 150, which pierce and contact each of the two conductors 138, 140 in the wire 136.

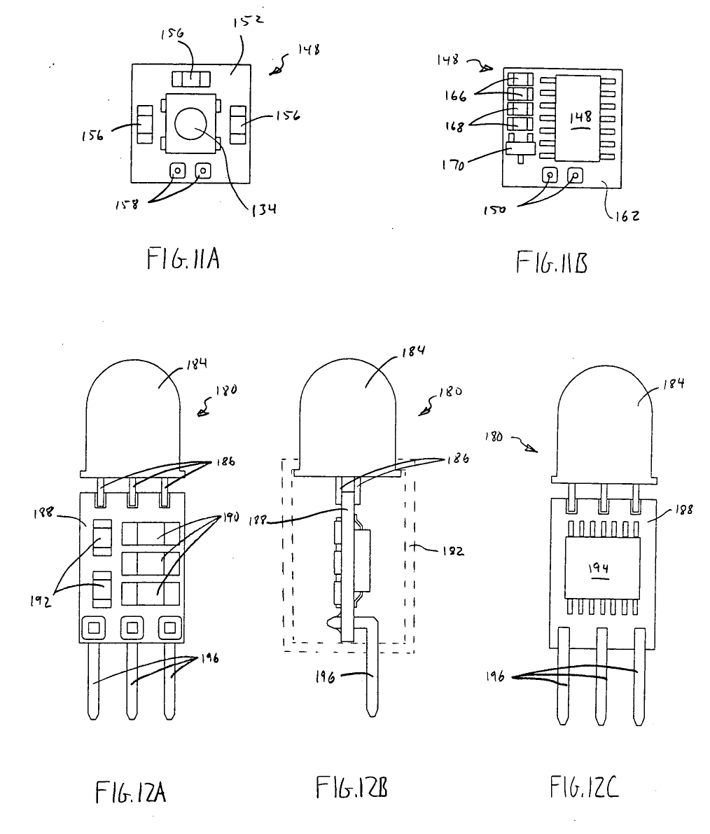

Though having only two conductors, the embodiment of FIGS. 8-10 can provide the same functionality as the three-wire embodiment. The circuitry of the two-wire embodiment is similar to that of the three-wire embodiment. As shown in FIG. 11A, the top 152 of the circuit board 154 includes the LED array 134, a group of resistors 156, and solder points 158 for the two pins 150. The bottom 162 of the circuit board, however, differs in more respects. In addition to the microprocessor chip 148, a group of resistors 166, and the two pins, the bottom of the circuit board includes some additional resistors 168 and a voltage regulator 170. In this embodiment, control signals for the node are superimposed upon the DC current traveling through the power/data wire 140. The voltage regulator with the associated resistor divider network and internal analog comparator allow the control signals to be distinguished from the background electrical current, so that the one data/power wire can provide both power and independent control data to each node. Consequently, the full range of operational flexibility of each LED node can be exploited independently using a two-wire conductor, rather than requiring a wire with three or more conductors.

Additional node variations can also be provided. For example, a stand-alone node (not shown) can be produced that is capable of performing desired functions without an interface or controller. In such an embodiment, each node can include its own connection to a power supply, and its own voltage regulator. The control circuitry of the node will be configured to store one or more control programs, and loop through the operations of these programs in any programmed manner. As another variation, a group of one or more nodes (not shown) can be configured for wireless connection to an interface. In this embodiment, a common wire (e.g. a two-conductor wire) can provide power to the group of nodes, or the nodes can have their own power supply as mentioned above, and the microprocessor of each node can each include wireless receiver circuitry. The interface can be configured to transmit wireless control signals, which are received by each node, according to each node's unique address.

Other variations are also possible. For example, individual nodes can be provided with more than one LED array (not shown). Additionally, node types for interconnecting different strings of nodes can also be produced. For example, a node that splits and extends a wire (e.g. a “Y” adapter or butt connector, not shown) can be used to connect more than one wire or strand together. Nodes that provide connections to music equipment (not shown), etc. can also be provided. These types of interconnecting nodes can include an LED array and related circuitry, as described above, or they can simply include connector pins for making contact between the respective conductors of the connected wires. Other node types can also be provided for non-electrical purposes, such as clamp nodes or connector nodes for facilitating connection of the wire to support structures.

In both the three-wire and two-wire embodiments, the wire can be SPT (Stranded, Parallel, Thermoplastic) wire. Stranded wire is preferred for use with the contact pins 42, so that piercing a conductor to make contact does not potentially sever the wire. However, solid core wire can also be used with the provision of contact spades (not shown), rather than pins. It will be apparent that the gauge of the conductors 46 will be dependent upon the length of a given wire, the number of nodes disposed on the wire, and the power requirements of each node. For example, the inventor has found that 18 gauge wire is sufficient for a strand of 100 nodes that is 100 feet long, with each node drawing as much as 100 milliamps of current, and consuming as much as 500 milliwatts of power.

The multiple conductor wire can be clad in UV resistant insulation. Where outdoor use is intended, it is also desirable be heat and cold resistant. A variety of colors can be used for the wire, such as back, white, green, brown, etc. Moreover, the wire can have color codes or other indicia, such as built-in polarity and length-interval indicators to promote proper orientation of the LED nodes upon the wire, and to help guide a user in placement of the nodes at a desired spacing. For example, as shown in FIG. 1, the data wire 26 can have a color or a stripe 172 that is different from the rest of the wire, that color corresponding to a color marking (174 in FIG. 2) upon or near the channel for receiving the data wire, or on the contact pin that is intended to connect to the data wire. Similarly, length indicia 176 can be provided on the wire indicating length intervals. Like the housing, it is desirable that the wire meet IP 64 or NEMA 3 ratings, though this is not required. Because the wire is relatively inexpensive, after too many holes have been made, the wire can simply be discarded and replaced.

Shown in FIGS. 12A-C is another alternative configuration for an LED node 180 in accordance with the present invention. This configuration includes the functional features of the embodiment of FIGS. 2-5, but provides an elongate shape, more like that of a conventional light bulb, rather than the generally flat configuration of the embodiment of FIG. 2. An outline of one possible configuration for a housing 182 for this embodiment is shown in dashed lines in FIG. 12B.

The LED 184 in the embodiment of FIG. 12 is a dome-type LED having six leads 186 (three per side). One LED device that is suitable for this embodiment is item SSL-LX5099SIUBSUGB, available from Lumex. This particular device is a 3-color LED. Another LED that could be used is a 2-color LED from Panasonic, item no. LN11WP23. In the embodiment of FIG. 12, the stubs of the three leads 186 for the LED are attached to the top edge of the circuit board 188. The circuit board includes substantially the same control circuitry described above. On one side, the circuit board includes capacitors 190 and resistors 192, and on the other side includes a microprocessor chip 194, as discussed above.

Attached to the bottom of the circuit board 188 are three pins or contacts 196, that can be configured to pierce insulation of a wire, in the manner disclosed above, or can be configured to attach to a connector that is in turn connected to a multiple conductor wire, or to a controlling circuit or another printed circuit board. The device of FIG. 12 operates in substantially the same manner and on the same principles as the 3-wire LED node disclosed above, but provides a different shape that can be more desirable in certain circumstances. It will be apparent that many other shapes, sizes, and configurations of LED nodes can also be devised by one skilled in the art. Additionally, a two-wire version in the elongate configuration of FIG. 12 can also be provided.

The various node embodiments disclosed herein are intended to be connected to an interface that controls their operation, and/or stores control commands/programming instructions. Referring again to FIG. 1, an interface 22 is connected to the multiple conductor wire 24 via a terminal block 200, and is connectable to an electrical power source (e.g. household AC) via a power cord 202, which can include a transformer 204 to provide DC power for the system. The program for the interface can be initially provided via a temporary hard-wire connection to a controlling device. As used herein, the term “controlling device” is intended to refer to any electrical device from which control program instructions can be downloaded to the interface or to the nodes through the interface, or to the nodes directly. A variety of controlling devices can be used to provide the programming instructions. For example, a personal computer can be the controlling device. Other digital devices can also be used as the controlling device. For example, a PDA, a flash memory card, or a purpose-built controller can be provided or adapted for this purpose. In the embodiment of FIG. 1, a data cable 206 and connector 208 (e.g. an RS-232-type connector, a USB connector, etc.) are provided to allow programming of the interface through a hard-wire connection.

Other methods of providing programming instructions to the interface can also be provided. For example, program instructions can be permanently stored in memory in the interface, such as at manufacture or afterward. Alternatively, the interface 22 can include an infrared communications port 210, similar to that found on PDAs and other devices. This would allow one to send programming instructions from a PDA 211 or other device. Alternatively, the interface can include a radio frequency receiver 212 for receiving programming instructions from a controlling device (e.g. a personal computer, PDA etc.) via a radio link. This can include communications using Bluetooth® or some other RF communications format. The interface can also include circuitry for a small web server, allowing a user to program and control the LED lighting system through the world-wide-web. Such small servers are commercially available, and have been used to allow remote control of a variety of devices, such as vending machines, small household appliances, etc., via the Internet.

Once the programming instructions are provided to the interface, the instructions are transmitted to the nodes via the multiple conductor wire, and the interconnection to the controlling device can be terminated. Indeed, once the nodes have been programmed (which can be done at the factory or by the user), they no longer require the interface for control purposes. Instead, the nodes can simply run the commands that are stored in their non-volatile EEPROM memory, with the interface merely providing a connection for electrical power, and possibly a timing signal, as discussed below.

While the interface can be configured in various ways, in one embodiment the interface stores commands in its own memory only long enough to ensure that the entire command has been received from the PC or other controlling device before sending the command to the nodes. The main purpose of the interface is: (1) to allow a physical connection between the controlling device and the nodes; (2) to modify and amplify the data signal between the controlling device and the nodes; (3) to provide a synchronization or timing signal to the nodes to synchronize the execution of their commands; (4) to provide an electrical connection between the power adapter and the nodes; and (5) to provide proper power-on timing to the nodes. Under normal operation, once the control program information is transmitted to each node, the interface can keep control of the nodes only to the extent that it powers them on and off when directed to do so by the controlling device.

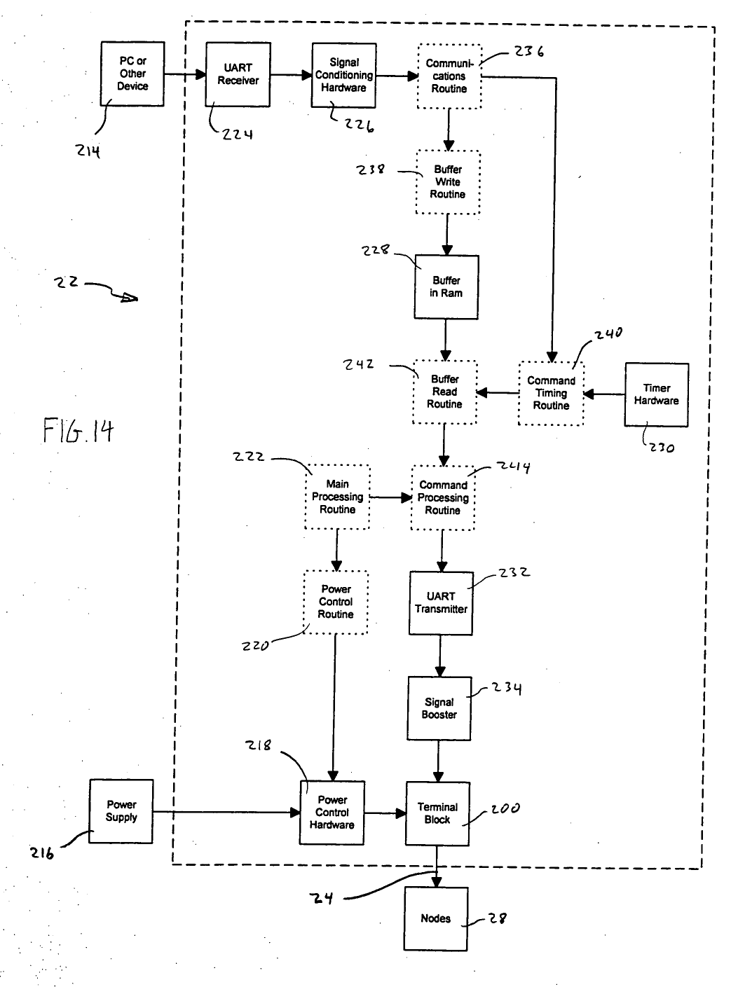

The hardware and operating routines for one embodiment of the interface are shown in a block diagram in FIG. 14. Hardware components of the interface are shown as solid line boxes, while the software steps are shown as dashed line boxes. All of these hardware components are associated with the interface, and operate according to the programming steps shown. As noted above, the interface is configured to receive programming input from a PC or other controlling device 214, and to receive power from a power supply 216. The power supply is connected to power control circuitry 218, which is controlled by a power control routine 220 associated with the main processing routine 222, and is then routed through the terminal block 200, and then to the multi-conductor wire 24 to be directed to the nodes 28. The data connection is connected to a UART receiver 224, which sends the data signals through signal conditioning circuitry 226. For handling the control signals, the interface includes a memory buffer 228, a timer circuit 230, a UART transmitter 232, and a signal booster 234. Following the signal booster, the control signals are routed through the terminal block, and thence to each node through the wire.

Upon receiving the control signals or programming instructions through the receiver and signal conditioning circuits, the interface 22 implements a communications routine 236 and buffer write routine 238 to place data into the memory of the nodes. The communications routine is also interconnected with a command timing routine 240 associated with the timer 230, to allow the buffer read routine 242 to read data from the memory buffer 228 at the proper time.

The main routines of the interface are the command processing routine 244 and the main processing routine 222. These routines process the programming instructions to convert the program instructions into individual signals for each node, and to send these signals to the nodes through the UART transmitter 232. The programming instructions can control the nodes in a variety of ways. Advantageously, in the embodiment shown, the interface has a default 57600 BPS bit rate between the interface and nodes. Higher and lower rates are also possible. This allows individual commands to be sent to individual nodes (i.e. one command to each unique node address) very rapidly. The interface can also be configured to send out other types of commands, such as family commands—i.e. commands received and executed by a specific set or group of nodes. For example, address ranges, rather than one specific node address, can be specified when sending commands. Alternatively, the interface can send global commands—commands received and executed by all nodes.

The nodes can operate according to immediate commands and/or queued commands. Each node can store a specific set of operating instructions in a queue, and execute them at certain global timer values. For example, the interface 22 can send out a global timing signal to all node addresses. This allows the nodes to operate in a synchronized manner, without the interface having to send operation signals simultaneously.

The programming can include a variety of commands and command types. It can include implemented commands, such as “set color,” “set morph color and duration,” “delay,” and “loop.” The “set color” command provides an initial color value for the LED array of a given node. The “set morph color and duration” command is the “morph” function described above. A “delay” command simply waits for a specified period of time before continuing the execution of commands. A “loop” command jumps back a specified number of commands and re-executes them. For a loop command, the number of cycles can also be specified.

It is also possible to store commands (as opposed to configuration data) in EEPROM. This allows commands to be executed out of EEPROM when the node is initially powered up, without having to program it first. These commands need not be written to EEPROM with the “write data to EEPROM” command though. Instead, there can be a special command that, once executed, causes all subsequent commands to be stored in EEPROM. Another command can stop subsequent commands from being stored in EEPROM. The “write command to EEPROM” function can include commands such as “set virtual address,” “reset device to factory defaults,” and “blink address.” The “blink address” command is similar to the morph, delay, and loop commands. Once received, the “blink address” command causes the nodes to “blink” their address. For example, node number 123 would blink its red LED one time, its green LED two times, and its blue LED three times. This can help a user easily identify which nodes are which.

The nodes can also be programmed to execute other commands. For example, a “flush command queue” command can be programmed, which causes the node to erase all commands that have been received and are stored in its command queue up to that point. A “random RGB values/patterns” command can also be provided, as described above. A “read device data” command can also be provided to cause a node to send certain requested information back to the interface, such as feedback from a sensor node. This information can then be sent to the PC or other controlling device. Many other commands are also possible.

The programming can also write data to the EEPROM. Certain configuration data is stored in the EEPROM. Some of this data includes the virtual address, initial POR (Power-on Reset) indicator, default POR red, green, and blue values, etc. The “write data to EEPROM” command allows this EEPROM configuration data to be modified. It allows the setting of morph and delay values, and setting of the run-mode.

The invention thus provides a modular lighting system that is simple in design, yet flexible in its use. It provides a system of independently controllable LEDs on a common control wire. The LEDs can be placed anywhere along the wire, and are configured for removal and replacement at a different location or on a new wire. Further, the LEDs each include their own microprocessor with a unique digital address that allows selective independent control of each LED in the group of LEDs using a single data line.

The system is very flexible and versatile. Each node is controlled by its own microprocessor. All nodes share a common cable for data signals, and power. Each node can be positioned as desired along the cable. Each node can be easily snapped onto and removed from the cable. Each node can utilize any color, from simple white LEDs, to red-green-blue LEDs, which allow over 16 million color combinations.

Each node has a unique address and can operate independently of the others. Each node features nonvolatile memory that allows it to retain its “program”, even after being powered off. Each node can be programmed thousands of times, and once programmed, each node only requires a power supply to run (e.g. no “interface” is required). Each node receives and processes commands specifically sent to it, and can queue and loop through these commands repeatedly. These commands can be stored in volatile and non-volatile memory. Each node can produce special lighting effects.

The system can be configured for indoor or outdoor use, and any color of LED can be used. Advantageously, however, newer red/green/blue LEDs can be used to allow a greater range of color selectivity. The system is designed so that after use in a particular configuration, the nodes can be removed from the wire for storage or for reconfiguration of the system. After removing the nodes from the wire, the wire will have many breaches of its insulation, and can be discarded. A new wire can be obtained for the next use. Given the relatively low cost of wire, replacing the wire for each new usage or configuration is relatively inexpensive and simple.

There are many possible applications for this invention. The modular lighting system is well suited for decorative lighting purposes, but is not limited to this application. It can be used for Christmas tree and other holiday lighting, lighting in theatres, concerts, clubs, restaurants, emergency lighting, amusement park rides, nightlights, lamps, and indicator lighting. The invention is also readily applicable for home and architectural lighting, such as above cupboards and crown molding to project light onto a ceiling, underneath cupboards to direct lighting onto counters, and underneath counters to direct light onto the floor. It can be used along stairs, for home theater lighting, and in display cases, hutches, curio cabinets, and the like. It can also be used outdoors for lighting along pathways and in trees and plants. The invention can also be used for vehicle lighting, such as ambiance lighting and instrumentation back-lighting for cars, trucks, and boats. It can also be used for lighting for floats in parades, and for custom stereo systems, including transparent speaker enclosures. Those skilled in the art will recognize that there are many other possible applications.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A modular lighting system, comprising:
a) a multiple conductor wire, including a common data wire; and
b) a plurality of nodes, disposed along the multiple conductor wire, each node including
i) an LED; and
ii) a node microprocessor, having a unique address, configured to independently control illumination of the LED according to node-specific operating instructions transmitted via the common data wire.

2. A system in accordance with claim 1, further comprising an interface, configured to send the node-specific operating instructions to each of the plurality of nodes via the common data wire.

3. A system in accordance with claim 2, wherein the interface is configured to send a timing signal to each node, so as to allow synchronicity of operation of the plurality of nodes.

4. A system in accordance with claim 2, further comprising a controlling device, selectively interconnectable with the interface, configured to provide the node-specific operating instructions to the interface.

5. A system in accordance with claim 4, wherein the interface is configured to store the node-specific operating instructions in interface memory, and to transmit the control instructions to the nodes for execution.

6. A system in accordance with claim 4, wherein the node microprocessor is configured to store the node-specific operating instructions in node memory, and to execute the operating instructions until further operating instructions are received via the data wire.

7. A system in accordance with claim 1, wherein the LED has multiple operational states.

8. A system in accordance with claim 1, wherein the multiple conductor wire consists of the data wire and a ground wire, the data wire being configured to provide (i) control instructions and (ii) electrical power for each of the plurality of nodes.

9. A system in accordance with claim 1, wherein the multiple conductor wire consists of the data wire, a power supply wire, and a ground wire.

10. A system in accordance with claim 1, wherein the node microprocessor is configured to receive the node-specific operating instructions via the data wire, to store the node-specific operating instructions in memory, and to cause the LED to illuminate based upon the operating instructions until further operating instructions are received via the data wire.

11. A system in accordance with claim 1, wherein the plurality of nodes are configured to selectively attach and reattach to the multiple conductor wire.

12. A lighting device, comprising:
a) an LED, having multiple operational states; and
b) a microprocessor circuit, associated only with the LED and having a unique digital address, configured to receive control signals for only the LED via a data wire, and to control illumination of only the LED according to the control signals.

13. A device in accordance with claim 12, wherein the LED is a red-green-blue LED.

14. A device in accordance with claim 12, wherein the microprocessor circuit is configured to receive operational instructions via the data wire, to store the operational instructions in memory, and to illuminate the LED based upon the operational instructions until further operational instructions are received via the data wire.

15. A device in accordance with claim 12, wherein the microprocessor circuit includes a voltage regulator, a resistor divider network, and an internal analog comparator, configured to allow control signals to be distinguished from background electrical current, so as to allow the data wire to also provide electrical power to the lighting device.

16. A device in accordance with claim 12, wherein the LED and microprocessor circuit are enclosed within a housing having a releasable connector that is configured to selectively attach and reattach the lighting device to any desired location on a multiple conductor wire.

17. A modular lighting device, comprising:
a) a microprocessor circuit, having a unique address;
b) an LED, operably connected to the microprocessor circuit and controlled thereby;
c) a housing, enclosing the microprocessor circuit and the LED, and configured to allow passage of light from the LED; and
d) a releasable connector, associated with the housing, having a plurality of contacts interconnected to the microprocessor circuit, the releasable connector being configured to selectively attach and reattach the housing to a desired location on a multiple conductor wire including a data wire, with the plurality of contacts each contacting one conductor of the wire, so as to allow the LED to be independently controlled based upon signals received through the data wire.

18. A device in accordance with claim 17, wherein the plurality of contacts are configured to pierce insulation of the multiple conductor wire upon connection thereto, so as to establish electrical contact with a respective conductor.

19. A device in accordance with claim 17, wherein the housing is substantially water-tight, so as to protect the microprocessor circuit and the LED from environmental conditions.

20. A device in accordance with claim 17, wherein the housing comprises a top portion, containing the LED and the microprocessor circuit, the contacts extending downwardly therefrom, and a bottom portion, configured to releasably attach to the top portion with a portion of the multiple conductor wire disposed therebetween.

21. A device in accordance with claim 20, wherein the top portion and bottom portion have an asymmetrical shape, configured to correspond to an asymmetrical shape of the conductor wire, such that the housing can be attached to the wire in only one orientation.

22. A device in accordance with claim 17, wherein the housing includes optical elements configured to modify light dispersion characteristics of the LED.
